(19) United States
(12) Patent Application Publication
(10) Pub. No.: US 2021/0064583 A1
(43) Pub. Date: Mar. 4, 2021

(54) METHOD FOR INTEGRATED GENERATION OF AN AUDIT REPORT

(71) Applicant: Audimex Ag, Augsburg (DE)

(72) Inventor: Stefan Berchtold, Augsburg (DE)

(21) Appl. No.: 16/553,493

(22) Filed: Aug. 28, 2019

(51) Int. Cl. G06F 16/176; G06F 16/18; G06F 16/182

(52) U.S. Cl. CPC G06F 16/1767; G06F 16/1824; G06F 16/1873

(57) ABSTRACT

A method for integrated generation of an audit report accessible by plural users that includes the steps of providing a computer connected to a communications network, loading audit software into the computer, providing a display for the computer for viewing by a user, generating an editable audit report from a database, and displaying the editable audit report on the display. The user enters data into the editable audit report which provides a template for entry of the data where the data entered into the editable audit report is stored in the database.

### FIELD OF THE INVENTION

The invention generally relates to a method for integrated generation of an audit report.

### BACKGROUND OF THE INVENTION

Audit reports result from an audit by an internal audit department or other internal and external controlling entities in businesses and organizations. The audit report provides information regarding the audited object, e.g. a legal entity or a business process, describes background and the scope of the audit.

There are several methodologies for generating an audit report with current audit practices. For example, the audit report may be generated in an external document which is separate to the audit documentation. Another example, is the audit report may be generated in an external document which is separate to the audit documentation but an interpreter analyzes the report at the end of report writing and stores contents in the database of the audit software such that existing contents from the audit documentation are overwritten. Yet another example is where the auditor enters all the contents including texts, findings, measures, and any other relevant materials that influence the audit report into an audit software and then generating the audit report using a template. Unfortunately, this methodology results in the audit report being repeatedly generated because the underlying software is being worked on rather than the audit report itself. Yet another example, is where the audit report is initially generated from the audit documentation, then the audit report, document is processed further, then portions of the audit report are extracted from the audit report document, and then transposed back into the audit software thereby implementing an update of the audit information.

Prior art methods, such as the above methods, have media interruptions and inconsistencies generated during report writing and generated through redundant data storage, and/or the audit report cannot be worked on in its entirety. Inconsistency of the data is very critical since measures are monitored in a subsequent portion of the audit process to assure measures from the audit report are correctly implemented. When the audit report is inconsistent with the contents of the audit software other measures are monitored that differ from the measures that were specified in the audit report. This requires a substantial manual transposition effort and subsequent checking.

Additionally, current audit support has several problems depending on the variant including:
The report is not visible yet while performing the audit since the report is only, generated after the audit.
The report cannot be written cooperatively since only one text document exists and only one person can work on the text document at a time.
Changes performed during “report drafting” and “report reconciliation” must be introduced back into the database manually for documentation purposes (consistency and traceability of the audit results). While some audit systems have the option to automatically read simple text changes from the audit report and to write them back into the database, these audit systems are unable to implement structural and complex changes. For example, changing the weight of a finding can cause the finding to appear in the management summary instead of appearing in the appendix,
Consistency of the audit report and of contents of the database can only be controlled manually with difficulty since the text document has to be compared to contents of the database in many details.
Consistency of the data within the report cannot be assured since word processors allow any type of changes and automatic controls from the software do not work in the word processor (e.g. mandatory fields, business rules, statistical tables, texts which occur repeatedly in the report).
Formatting an audit report is typically performed according to strict rules. When the auditor has a freely editable document available to himself it is very difficult to enforce these rules.
When information like code of a responsible department, an email address or a date value is entered into the report there is a high probability of erroneous entries and thus of an incorrect report.

Accordingly, there is a strong need in for an automated audit report system capable of addressing the foregoing problems.

### BRIEF SUMMARY OF THE INVENTION

An exemplary method for integrated generation of an audit report accessible by plural users according to the invention includes the steps of providing a computer connected to a communications network, loading audit software into the computer, providing a display for the computer for viewing by a user, generating an editable audit report from a database, and displaying the editable audit report on the display. The user enters data into the editable audit report where the editable audit report provides a template for entry of the data such that the data entered into the editable audit report is stored in the database.

The audit report may be continuously visible during a processing of the audit report.

Objects may be integrated into an external word processing system or in that the audit software includes an integrated word processing system which can also tie in objects. The objects may include findings or measures.

The storing the data in the database may occur immediately.

The method may further include generating a list of objects which are loaded to generate the editable audit report.

The editable audit report may be generated from a current content of the database when the audit software is started. The editable audit report may include editable and non-editable portions, which of the portions are editable and which of the portions are non-editable is determined from an object list compiled after the editable audit report is generated from the current content of the database. When an object in the object list is changed, all objects in the object list that are affected by the change may be changed in the database. For each user of the audit software, the audit software may monitor for when the object in the object list is changed and changes the editable audit report to reflect the changes in the object list. The audit software for each user may have a time stamp of when each object in the object list was last updated, and each object in the object list in the database may include a time stamp indicating when it was last changed.

Plural users may work on the editable audit report simultaneously. The editable audit report may include editable and non-editable portions, and each of the editable portions may be editable by only one the plural users at a time. When a user of the plural uses moves a cursor into an editable portion of the editable portions, a check may be made by the audit software whether another user of the plural users is currently editing that editable portion of the editable portions. When an editable portion of the editable portions is being edited by one of the plural users, this editable portion of the editable portions may become blocked from editing until at least one of the following occurs: the one of the plural users exits the editable portion of the editable portions that was blocked from editing, or the one of the plural users exits the audit software, or the one of the plural users is inactive for a predetermined period of time, or the one of the plural users actively overrides the blocking. When an editable object of the editable portions is being edited by one of the plural users, this editable object of the editable portions may become blocked from editing by being listed as the current user until the one of the plural users is deleted for the current user for the editable object of the editable portions.

### BRIEF DESCRIPTION OF THE DRAWINGS

The invention will be described in detail with reference to the following drawings in which like reference numerals refer to like elements wherein:

FIG. 1 illustrates an exemplary embodiment of a portion of an audit report; and

FIG. 2 illustrates an exemplary embodiment where the method according to the invention may be implemented.

### DETAILED DESCRIPTION

A typical audit is performed as follows:
Audit preparation: it is being determined what is being audited, where the audit is performed, the audit assignment, and the methodology of the audit, which topics are being audited and which audit steps are to be performed, and the like.
Audit execution: the actual audit steps are performed and documented. Furthermore, findings are issued as an essential result of the audit that specify identified problems and risks and associated measures, by which actions that solve the problems or mitigate the identified risks.
Report writing: a first draft is generated from the results of the audit and from the master data. The first draft is then manually refined by the audit team into a “draft audit report”. Findings and measures are consolidated and amended again in the draft audit.
Audit report reconciliation: the draft audit report is reconciled within the audit team, with management of the audited entity and with the manager of an internal audit department or the company unit in charge.
Final report: the final report document is generated and then officially distributed to audited parties and other parties.
Measure implementation monitoring: implementation of measures is monitored by the auditor. Here is it monitored whether the audited parties comply with “who”, “up to when” and “what”.

The audit report is typically generated in a word processing format (.docx, .rtf and the like). There are four typical methods for generating an audit report used by internal and external audit departments:

a) External report writing: using this method the auditor operates in two worlds. On the one hand side the auditor generates audit documentation with or without software support. Independently therefrom the auditor generates an audit report in a word processing system. The audit report is then reconciled, signed off and distributed. Eventually the final findings and measures from the audit report are transposed or reconciled in the audit software and thus in the measure monitoring.

b) External report writing with interpreter: this method is similar to external report writing but after generating the final text report an additional step is performed where the audit report is interpreted by syntax rules and analyzed. Thus, important data like findings, measures and other properties can be substantially subtracted form the report. These data are then stored in the database of the audit software. Audit documentation, in particular findings and measures, already stored in the audit software is either overwritten or duplicated according to this method.

c) Repeated report generation: in this method, the audit software generates the audit report from data in the database of the audit software (texts, findings, measures, audit actions, master data of the audit, etc.) after completion of the audit. The auditor always works only in the audit software and changes texts and other data in the audit software. Thereafter the auditor generates the audit report periodically in order to be able and check the audit report in one piece. However, the auditor never sees the audit report while entering data but only thereafter. Thus, normal writing in one piece is not possible.

d) Generating the audit report with back writing: according to this method an audit report is generated from data in the database of the audit software (texts, findings, measures, audit actions, master data of the audit, and the like) together with an audit template after completing the audit. The audit report is then worked on and reconciled as described in the external report writing. Conventional audit software is furthermore capable to integrate individual texts that were changed in the report back into the database of the software. This is achieved by write protecting the document in sections that are not to be modified. The modifiable locations are marked and can be transposed backward from the audit report into the audit software. Typically, only text is supported but not fields like select lists, date fields, and the like.

However, unlike the prior art methods above, the method according to the invention integrates the audit software directly into a word processing system and stores the audit report during report writing not as a document as is done in the prior art but in modifiable components. This has the advantages of avoiding redundant data storage and avoiding the problems recited supra.

The integration is performed in that objects like findings or measures are integrated into an external word processing system (e.g., Microsoft Word) or, in that the audit software includes an integrated word processing system which can also tie in objects. It is advantageous in this context that the auditor always feels like he is working on a document that is as close to the final report as possible. This is achieved in that the auditor works on a perceived document in the word processing system. Storing the individual components of the report is done in the background and thus in a manner that is not noticed by the user.

Integrated Audit Console

The method according to the invention that uses integrated report writing solves all problems recited supra.

The basis of the report console is a word processor. The word processor can be integrated into the software or the method can be integrated into an existing word processor like Microsoft Word or any other word processor that fulfils the necessary technical requirements allowing implementation of the method according to the invention. From a user point of view the method according to the invention runs within the word processor.

In essence, the invention according to the invention is the word processor is not used to generate a document like in the prior art but as a form. Thus, the word processor provides a framework into which the user enters the data that is relevant for the report. All changes to text or other objects are immediately stored in the database. This has the advantage of it avoids media interruption.

Report Generation

In a first step of the method, the audit report is generated from contents of the database and a report template. The result of this generation process is displayed in the word processor and is editable in the word processor. The format of the document in the word processor is irrelevant for the method according to the invention and up to this first step the method corresponds to the conventional method.

Generation of an Object List and Marking of Objects

During the generation of the audit report a list of objects is generated which influence the audit report (object list). These are the objects that had to be loaded in order to generate the audit report, either because the objects were displayed or indirectly because the objects had influence upon the displaying or structure of the report.

In the template a type of processing of a relational text section is defined (type of editor) and may include, for example, the following:
text is processed in line in the word processor,
a field is processed in a pop-up mask in the word processor,
a number of fields of a data set is processed in a pop-up mask in the word processor,
reference to a corresponding object mask in the software,
reference to a corresponding overview mask in the software, and/or
no processing allowed.

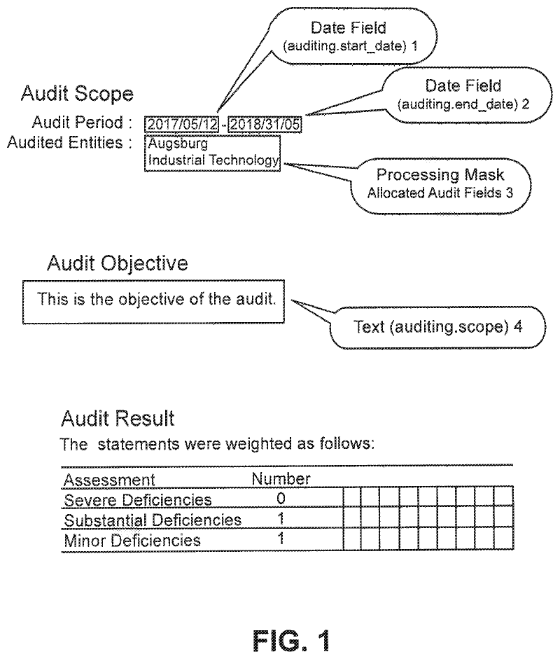

FIG. 1 illustrates an exemplary embodiment of a portion of an audit report with processing ability (detail). FIG. 1 includes an audit scope with an audit period defined by date fields (auditing.start_date 1 and auditing.end_date 2) and audited entities defined by a processing mask (Allocated Audit Fields 3), an audit objective defined by text (auditing.scope 4), and an audit result.

This information which portion is being processed and how can be derived from the template in some embodiments. Thus, the displayed object is simply processed. Suitable editors are derived from the type of object. In particular cases the information is stored in the template may be specified by the author of the template. The following is stored in the object list for each object:
Table/class;
Column/property;
Object ID;
Type of editor;
Last update of the data set in the central database;
Currently editing user (auditor);
List of text sections that are influenced by the object, thus all relevant text sections are provided with a unique identification; and
Optionally and as far as possible template transformation which generates the displayed value from the raw data from the database.

Thus, it is evident for the method according to the invention within the text editor from which objects the respective portions of the document have been generated. Furthermore, it is known which text sections must be amended when a particular object changes. Using the template transformation changed database values can be transformed into a display value.

As an alternative to the object list, the same information could also be stored at each text section in the document.

Report Editing

When the report console is accessed in the audit software, the audit report is generated from the current database contents (c.f report generation).

In a next step the user can perform changes within the integrated word processor, however these changes are only permissible at particular sections, which are determined during forming of the object list (type of editor) which text sections these are. The editable sections and the associated actions can be divided in several classes (For example, pure text, database field/number of fields, additional structural processing, and cooperative report editing).

Pure Text

Here the user can work directly in place as customary in a word processor. When the user exits the portion in the document after editing the new text is immediately stored in the database. When storing is not possible due to lack of permission or technical problems the object is loaded again from the database of the audit software and the portion is write protected.

Database Field/Number of Fields

This designates typical information from a database like, for example, date values, floating point numbers, selected values, and the like. When the user puts the focus of the editor to a text section which was generated from this type of data, a new (pop-up) entry mask of the audit software opens which facilitates the adaptation of the corresponding value.

When the user stores the input, the information is immediately written into the database of the software. Since the mask is part of the application all checks like mandatory fields, consistency conditions, format checks, business rules, etc. function therein. Thus, the user can only store consistent and correct data. Thus, the data of the audit report is always correct according to these rules.

Additionally, the processed text section is updated accordingly with the value. Thus, it is appreciated that data is transformed into text in the document based on the logic of the template during report generation. As described in step 1, the method according to the invention only recognizes the underlying objects and properties. These are processed directly but not the resulting text. The resulting text is updated in the document using one of the following methods:
Replacement of the text section by a place holder which indicates that a property was changed (e.g., “????”, “####”, or the like),
Marking of the changed text section (e.g., by highlighting, track changes, or the like),
insertion of raw data from the database, or
repeated local performing of the transformation, which was defined in the template for this purpose.

Depending on the implementation of the method according to the invention, and the abilities of the template generator, one of the variants is selected.

Additional Structural Processing

During normal processing of the audit report, a situation can present itself where the audit report is be generally restructured. This can be caused by several situations such as:
change of logical sequence of text or statement,
combination of two findings,
deletion of one statement or of another object that influences the report,
change of master data, and/or
changes which influence the type of template (For example, changes of the type of audit).

This type of processing can be performed at any section in the audit software. This type of processing eventually changes the data on which the audit report is based for data that influences the audit report. Detecting and treatment of these situations will be described infra.

Cooperative Report Editing

In order to enable several users to work on an audit report simultaneously, the users open the report console in parallel or operate in the test software. This generates situations where an auditor sees data in his report console wherein the data was already changed by another auditor. The synchronization of the users working in parallel is performed by the central data administration in the audit software.

Detection of Changes

In order to be able to detect changes to objects that were performed by other users and that are visible in the report console, the report console checks in continuous and/or configurable time intervals whether changes to an object from the object list were performed in the database where the changes were performed after loading into the report console.

Thus, dates of the last change are queried from the object list for each object in the database. When these dates are later than the date stored in the object list for the last update the object is considered changed.

Reaction to Changes in the Audit Report

When a change to an object is detected one of the following actions may be taken:
Pure text: The text is replaced in the console and is thus immediately visible to the auditor.
Database fields: The text section (field) is treated as described in the preceding chapter (e.g., marked). Thus, the method is the same as if the user had changed the field.
For other changes: This relates, for example, to a deletion of objects or changes to objects which influence the report only indirectly, for example, master data. The report console signals to the user in this case that the report must be generated anew. This is performed by the user manually.

Blocking of Contents

When a user moves the cursor within the word processor into a changeable portion, it is checked whether another user is currently blocking that portion because by currently working on that portion.

The checking is performed by querying the central database for the respective object who is the currently working user, if any. When the object is blocked, the processing in the report console is denied and the object is write protected in the word processor.

When an object is not processed yet, this portion is also blocked for other users. The blocking is performed in that the currently working user is stored in the central database for the respective object.

The blocking is released when, for example, the following occur:
the user which has blocked the portion has exited that portion (cursor outside of the portion), or
the report console is closed, or
the session of the blocking user has timed out, or
a user actively removes the blocking by a manual action in the report console.

The release of the blocking occurs when the “currently working user” is deleted for the respective object.

Proactive Information of the Auditor

Which users have performed processing in the recent past at which locations is checked by the audit software at configurable uniform time intervals. Alternatively, the intervals may be non-uniform. This is visualized in the report console in order to prevent simultaneous processing of two portions right from the beginning which would otherwise cause conflict. The visualization can be performed, for example, by
Displaying an avatar of a respective user at an edge of the document,
marking the last portion in the document that has been changed with a comment, or
marking the last portion in the document that has been changed with a speech bubble which indicates a point in time (e.g., a date stamp) and a name of the user (e.g., a user identification).

Hardware

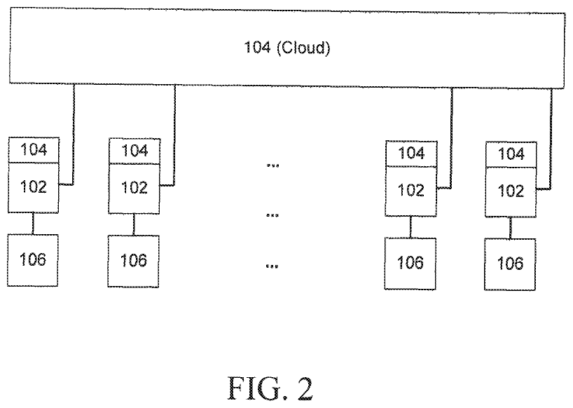

The hardware to implement the method according to the invention includes at least one computer, at least one display, and at least one storage medium. FIG. 2 illustrates an exemplary embodiment where the method according to the invention may be implemented. Here multiple computers 102 connected via one or more networks 104 (cloud, internet, ethernet, local area network, or the like). Each computer 102 runs the audit software which is loaded from a storage medium 104 (cloud, compact disk, hard drive, thumb drive, or the like). For each user, his or her respective computer 102 runs the audit software and displays the audit report on his or her respective display 106. The respective user is then able to work with the audit report as discussed above. The audit software can communicate over the network to implement the method according to the invention. Optionally additional devices such as printers, scanners and other devices may also be utilized with the computers 102.

Although several embodiments of the present invention and its advantages have been described in detail, it should be understood that changes, substitutions, transformations, modifications, variations, permutations and alterations may be made therein without departing from the teachings of the present invention, the spirit and the scope of the invention being set forth by the appended claims.

What is claimed is:

1. A method for integrated generation of an audit report accessible by plural users, the method comprising the steps of:
providing a computer connected to a communications network;
loading audit software into the computer;
providing a display for the computer for viewing by a user;
generating an editable audit report from a database;
displaying the editable audit report on the display; and
the user entering data into the editable audit report,
wherein the editable audit report provides a template for entry of the data, and
wherein the data entered into the editable audit report is stored in the database.

2. The method of claim 1, wherein the audit report is continuously visible during a complication of the audit report.

3. The method of claim 1, wherein the audit software is integrated directly into a word processor program that stores the editable audit report in modifiable components.

4. The method of claim 1, wherein objects are integrated into an external word processing system or in that the audit software includes an integrated word processing system which can also tie in objects.

5. The method of claim 4, wherein the objects include findings or measures.

6. The method of claim 1, wherein the audit software includes an integrated word processing system able to tie in objects.

7. The method of claim 1, wherein the storing the data in the database occurs immediately.

8. The method of claim 1, further comprising generating a list of objects which are loaded to generate the editable audit report.

9. The method of claim 1, wherein the editable audit report is generated from a current content of the database when the audit software is started.

10. The method of claim 9, wherein the editable audit report includes editable and non-editable portions, which of the portions are editable and which of the portions are non-editable is determined from an object list compiled after the editable audit report is generated from the current content of the database.

11. The method of claim 10, wherein when an object in the object list is changed, all objet the object list that are affected by the change are changed in the database.

12. The method of claim 10, wherein for each user of the audit software, the audit software monitors for when the object in the object list is changed and changes the editable audit report to reflect the changes in the object list.

13. The method of claim 12,
wherein the audit software for each user has a time stamp of when each object in the object list was last updated, and
wherein each object in the object list in the database includes a time stamp indicating when it was last changed.

14. The method of claim 1, wherein plural users can work on the editable audit report simultaneously.

15. The method of claim 14,
wherein the editable audit report includes editable and non-editable portions, and
wherein each of the editable portions is editable by only one the plural users at a time.

16. The method of claim 15, wherein when a user of the plural uses moves a cursor into an editable portion of the editable portions, a check is made by the audit software whether another user of the plural users is currently editing that editable portion of the editable portions.

17. The method of claim 15, wherein when an editable portion of the editable portions is being edited by one of the plural users, this editable portion of the editable portions becomes blocked from editing until at least one of the following occurs:
the one of the plural users exits the editable portion of the editable portions that was blocked from editing, or
the one of the plural users exits the audit software, or
the one of the plural users is inactive for a predetermined period of time, or
the one of the plural users actively overrides the blocking.

18. The method of claim 15, wherein when an editable object of the editable portions is being edited by one of the plural users, this editable object of the editable portions becomes blocked from editing by being listed as the current user until the one of the plural users is deleted for the current user for the editable object of the editable portions.
